(19) United States
(12) Patent Application Publication
(10) Pub. No.: US 2026/0039159 A1
(43) Pub. Date: Feb. 5, 2026

(54) ROTOR ASSEMBLIES FOR RADIAL/AXIAL PERMANENT MAGNET SYNCHRONOUS MACHINES AND METHODS FOR PRODUCING AXIAL PERMANENT MAGNET SYNCHRONOUS MACHINE ROTOR ASSEMBLIES

(71) Applicant: DEEPER PULSE, SARNIGUET (FR)

(72) Inventors: Youness RTIMI, SARNIGUET (FR); Théo CARPI, SARNIGUET (FR)

(21) Appl. No.: 19/139,150

(22) PCT Filed: Dec. 18, 2023
(86) PCT No.: PCT/EP2023/086488

§ 371 Date: Jun. 13, 2025

(30) Foreign Application Priority Data
Dec. 16, 2022 (FR) FR2213495

(51) Int. Cl. H02K 1/27; H02K 15/035

(52) U.S. Cl. CPC H02K 1/27; H02K 15/035

(57) ABSTRACT

The subject application discloses improved rotor assemblies containing permanent magnets, tailored for two distinct synchronous machine topologies—radial and axial flux machines.

Both rotor structures incorporate elongated bodies having soft-magnetic elements strategically arranged between permanent magnet groupings.

Uniquely, the soft-magnetic components feature an innovative conical geometry to focus magnetic flux.

The permanent magnets positioned on each side of an element share identical polarity to strengthen flux.

The particular shape of the intersection between soft-magnetic elements and permanent magnets allows spreading the stress linked to the centrifugal force applied to the permanent magnet during the motor operation.

Radial rotors create a circumferential air gap, while axial rotors have an axial-oriented gap.

Together, these advances aim to boost torque production and lower torque ripples to enhance overall performance.

The combination of tapered soft-magnetic cones, optimized magnet polarity, and air gaps demonstrating advancements in high-power permanent magnet rotor engineering for specialized synchronous machines.

### TECHNICAL FIELD

The subject application relates to rotor assemblies for radial/axial permanent magnet synchronous machines and methods for producing axial permanent magnet synchronous machine rotor assemblies. Similar devices are known from JP2010283978A, US2018/294685A1, US2017/244293A1, US2013111676A1, WO2022237024A1, JP2007151321A and FR2606951A1.

### BACKGROUND ART

Permanent magnet synchronous machines rely on embedded rotor magnets and strategically permeable rotor sections to create a magnetic flux for converting electrical and mechanical power.

However, conventional rotor designs face innate limitations regarding optimizing flux paths and output torque quality across operating speeds.

Specifically, leakage flux represents wasted potential, while torque ripple degrades system performance over time, accelerates aging, and generates noise.

In practice, rotors require considerable high-permeability soft magnetic material to guide flux around the cylinder, though not all material contributes effectively.

This overuse produces excess raw material waste and environmental pollution.

Recognizing these shortcomings, the inventors seek to devise a novel permanent magnet rotor topology that enhances flux control and torque smoothness using less raw material, to advance specialty synchronous machine rotors beyond existing inadequacies.

### SUMMARY OF SUBJECT APPLICATION

The subject application provides a rotor assembly for radial/axial permanent magnet synchronous machines and a method for producing an axial permanent magnet synchronous machine rotor assembly, as described in the accompanying claims.

Dependent claims describe specific embodiments of the subject application.

These and other aspects of the subject application will be apparent from an elucidated based on the embodiments described hereinafter.

### BRIEF DESCRIPTION OF DRAWINGS

Further details, aspects and embodiments of the subject application will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows an elongated body of a first permanent magnet rotor assembly according to the subject application.

FIG. 2 shows a cross section of a first interior permanent magnet rotor assembly.

FIG. 3 shows a zoomed-in view of FIG. 2.

FIG. 4 shows a partial exploded view of FIG. 2.

FIG. 5 shows a cross section of a first exterior permanent magnet rotor assembly.

FIG. 6 shows a zoomed-in view of FIG. 5.

FIG. 7 shows a partial exploded view of FIG. 5.

FIG. 8 shows the cross section of FIG. 2 with a focus on a first embodiment arrangement of the permanent magnet arrangement.

FIG. 9 shows the cross section of FIG. 2 with a focus on a second embodiment arrangement of the permanent magnet arrangement.

FIG. 10 shows a zoomed-in view of FIG. 5 with a focus on the structure of the soft-magnetic elements.

FIG. 11 shows a zoomed-in view of FIG. 2 with a focus on various embodiments of the structure of the soft-magnetic elements.

FIG. 12 shows a zoomed-in view of FIG. 2 with a focus on various embodiments of the structure of the permanent magnet arrangements.

FIG. 13 shows the cross section of FIG. 2 with a focus on the mechanical attachment of the rotor.

FIG. 14 shows an elongated body of a second permanent magnet rotor assembly according to the subject application.

FIG. 15 shows a longitudinal section of the second permanent magnet rotor assembly according to the subject application along with a stator.

FIG. 16 shows FIG. 15 with a focus on the second permanent magnet rotor assembly.

FIG. 17 shows an exploded view of FIG. 16.

FIG. 18 shows zoomed in views of FIG. 16 with a focus on the structure of the soft-magnetic elements and the permanent magnet arrangements.

FIG. 19 shows FIG. 16 with a focus on embodiments soft-magnetic elements and the permanent magnet arrangements.

FIG. 20 shows a longitudinal section of a double-sided motor based on the second permanent magnet rotor assembly.

FIG. 21 shows a schematic flow diagram according to the subject application.

FIG. 22 shows a result of at least one step of the schematic flow diagram of FIG. 21.

### DESCRIPTION OF EMBODIMENTS

Because the illustrated embodiments of the subject application may, for the most part, be composed of components known to the skilled person, details will not be explained in any greater extent than that considered necessary for the understanding and appreciation of the underlying concepts of the subject application, in order not to obfuscate or distract from the teachings of the subject application.

The subject application discloses improved rotor assemblies containing permanent magnets, tailored for two distinct synchronous machine topologies—radial and axial flux machines.

Both rotor structures incorporate elongated bodies having soft-magnetic elements strategically arranged between permanent magnet groupings.

Uniquely, the soft-magnetic components feature an innovative conical geometry to focus magnetic flux.

The permanent magnets positioned on each side of an element share identical polarity to strengthen flux.

The particular shape of the intersection between soft-magnetic elements and permanent magnets allows spreading the stress linked to the centrifugal force applied to the permanent magnet during the motor operation.

Radial rotors create a circumferential air gap, while axial rotors have an axial-oriented gap.

Together, these advances aim to boost torque production and lower torque ripples to enhance overall performance.

The combination of tapered soft-magnetic cones, optimized magnet polarity, and air gaps demonstrates advancements in high-power permanent magnet rotor engineering for specialized synchronous machines.

### A Radial Permanent Magnet Synchronous Machine Rotor Assembly

The subject application relates to a first permanent magnet rotor assembly specifically designed and built for use in a radial permanent magnet synchronous machine having a stator.

As used herein, the term ‘specifically designed and built for’ is meant to safeguard against inapplicable rotors being improperly interpreted as anticipatory prior art based on superficial resemblance alone, despite the lack of aptness for the stated radial flux machine application without further changes.

Indeed, the term ‘specifically designed and built for use in a radial permanent magnet synchronous machine’ serves to emphasize that the claimed rotor assembly is explicitly engineered and manufactured for the particular application specified. This excludes the possibility of any known product, even if superficially similar, being construed as anticipatory if in reality it is unsuitable for direct use in such a radial flux machine context without modification. The phrasing indicates that a rotor requiring adaptations to enable functioning as prescribed in the radial synchronous machine falls outside the scope of the claim's novelty. Rather, only a previously existing rotor structure simultaneously designed AND fabricated AND capable of actual operability within the claimed machine without adjustments could potentially challenge novelty.

The radial permanent magnet synchronous machine is of known type and therefore will not be further detailed.

The stator is of a known type. For instance, the stator may comprise windings that are arranged in a double-layer concentrated configuration specified by the “12/10” ratio between stator and rotor pole pairs (e.g. 60 vs 50). Also, to generate the required rotating magnetic flux, a dual three-phase winding scheme may be utilized. However, since the stator may use a standardized layout which is well established in electrical machine design, it will not be further detailed.

### Structure of the First Permanent Magnet Rotor Assembly

### An Elongated Body

Referring to FIG. 1, the first permanent magnet rotor assembly 100 comprises an elongated body 110.

In an embodiment, the elongated body 110 has a substantially cylindrical shape with desired dimensions.

In an example of the current embodiment, the elongated body 110 is a tubular body.

In another example of the current embodiment, the elongated body 110 is a hollow cylinder body.

Further, in the subject application, the elongated body 110 has a central longitudinal rotation axis 111, a circumference and a cross-section.

As used herein, the term ‘circumference’ is defined as an external circumferential surface of the elongated body 110.

Further, the cross-section is seen in a plane perpendicular to the central longitudinal rotation axis 111.

Particularly, the cross-section of the elongated body 110 exhibits an external circumferential dimension and a radial dimension perpendicular to the external circumferential dimension.

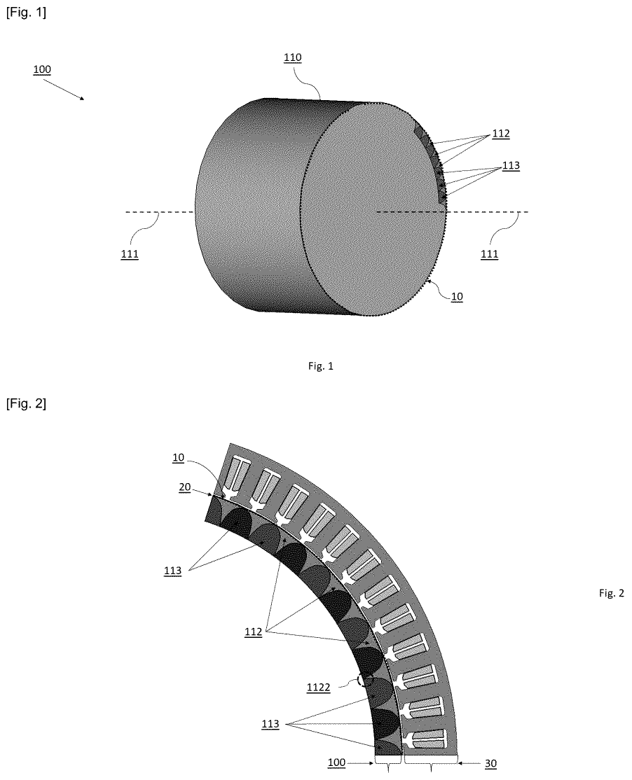

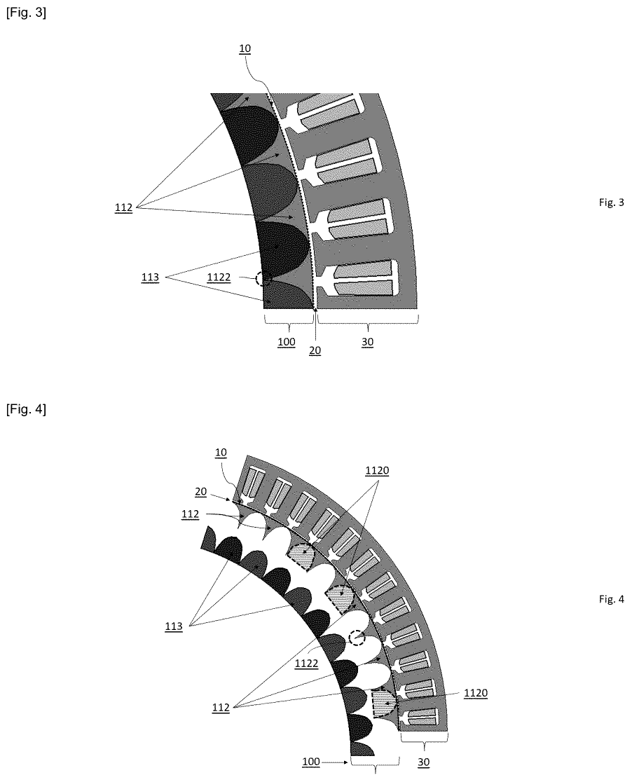

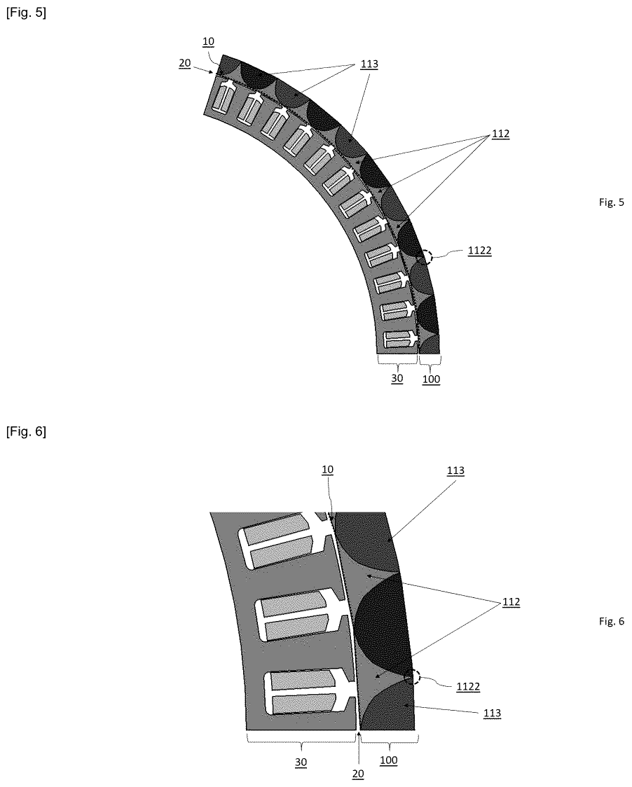

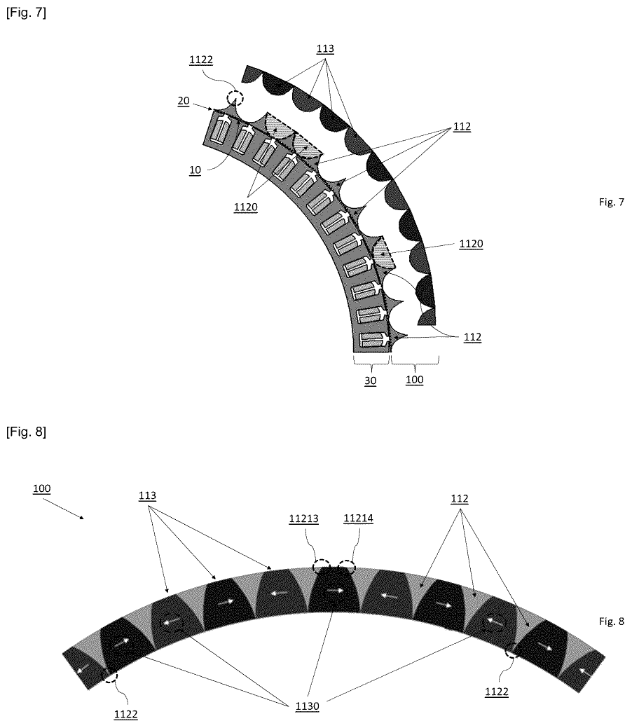

Furthermore, as shown in FIG. 1, FIG. 2, FIG. 3, FIG. 4, FIG. 5, FIG. 6 and FIG. 7, the cross-section has a perimeter line 10 that delimits the contour of the cross-section.

As used herein, the term ‘perimeter line’ is defined as the closed boundary delimiting the contour of the cross-section of the elongated body 110, comprising connected segments that encircle the cross-sectional area.

### Soft-Magnetic Elements

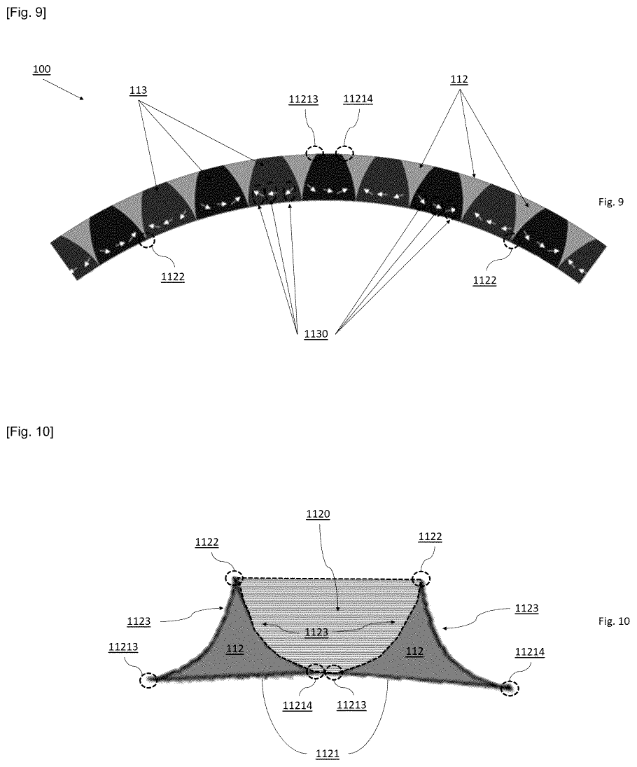

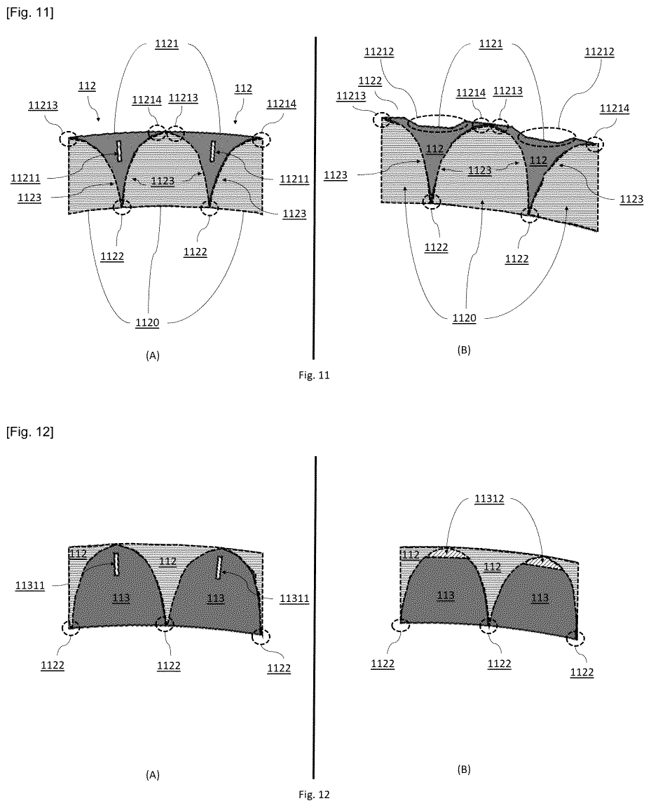

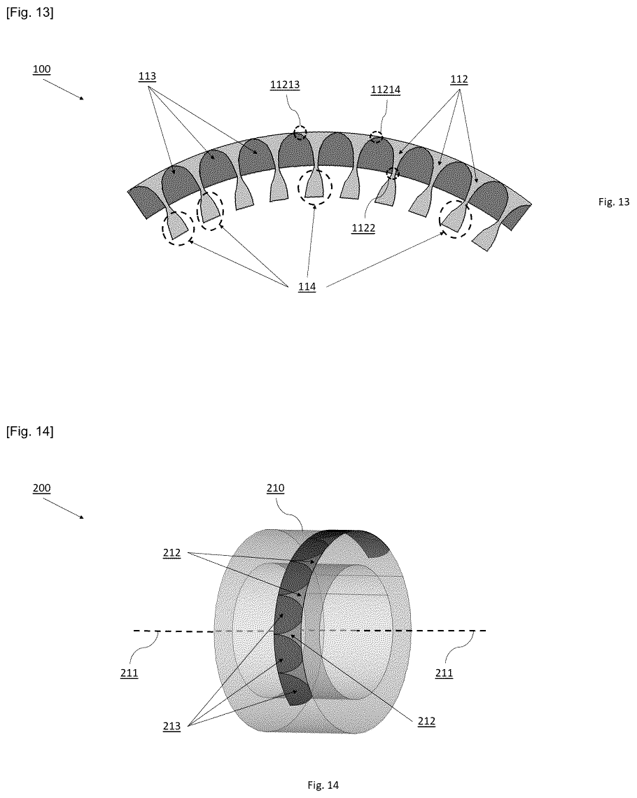

In the subject application, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, the cross-section of the elongated body 110 comprises one or more soft-magnetic elements 112.

### Soft-Magnetic Elements Material

In the subject application, the one or more soft-magnetic elements 112 are made of soft-magnetic material.

As used herein, the term ‘soft’ in ‘soft-magnetic material’ doesn't refer to the physical hardness of the material, but rather its ‘magnetic softness’, i.e., its ability to become magnetized and demagnetized easily.

In an embodiment, the soft-magnetic material is a soft ferromagnetic material which has a permanent spontaneous magnetization persisting without an external field.

In an example of the current embodiment, the soft ferromagnetic material is chosen from the group comprising: a ferrite, iron powder, bulk iron, cobalt and nickel.

However, other materials that have a magnetic permeability greater than that of air may be contemplated, without requiring any substantial modification of the subject application.

### Arrangement of Soft Magnetic Elements Relative to the Perimeter Line

In the subject application, the one or more soft-magnetic elements 112 are positioned with respect to the perimeter line 10 of the cross-section of the elongated body 110.

In particular, the one or more soft-magnetic elements 112 are arranged to extend above or below the perimeter line 10.

Indeed, FIG. 2, FIG. 3 and FIG. 4 illustrate an interior permanent magnet rotor assembly where the one or more soft-magnetic elements 112 are arranged to extend below the perimeter line 10.

Furthermore, FIG. 5, FIG. 6 and FIG. 7 illustrate an interior permanent magnet rotor assembly where the one or more soft-magnetic elements 112 are arranged to extend above the perimeter line 10.

In the subject application, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, the one or more soft-magnetic elements 112 are further arranged to be relative to each other and circumferentially adjacent to one another around the central longitudinal rotation axis 111.

Moreover, the one or more soft-magnetic elements 112 are also arranged to be spaced apart circumferentially, with a space 1120 existing between each adjacent pair of soft-magnetic elements 112.

In a first embodiment, the soft-magnetic elements 112 are arranged to be evenly spaced apart, with the space 1120 defined between each adjacent pair of soft-magnetic elements 112 being substantially equal.

In a second embodiment, the soft-magnetic elements 112 are arranged with variable spacing, with the space 1120 defined between each adjacent pair of soft-magnetic elements 112 varying.

As a result of the arrangement of the one or more soft-magnetic elements 112, as shown in FIG. 2, FIG. 3, FIG. 4, FIG. 5, FIG. 6 and FIG. 7, a circumferential radial non-magnetic gap 20 is created between a stator 30 and the perimeter line 10 of the cross-section.

In other words, the radial non-magnetic gap 20 encircles the perimeter line 10 of the cylindrical rotor cross-section.

In an example, the radial non-magnetic gap 20 comprises air.

In another example, the radial non-magnetic gap 20 comprises non-magnetic gases such as Nitrogen (N2), Carbon dioxide (CO2) or Helium sulfide.

In another example, the radial non-magnetic gap 20 comprises aluminum.

In another example, the radial non-magnetic gap 20 comprises plastic.

In another example, the radial non-magnetic gap 20 comprises resins such as carbon fiber/resin or fiberglass/epoxy resin.

In yet another example, the radial non-magnetic gap 20 comprises polymers such as ceramic/polymer composites (i.e., silicon nitride in an epoxy matrix).

However, the radial non-magnetic gap 20 may comprise other materials that have non-magnetic conductive properties, without requiring any substantial modification of the subject application.

### An Overall Conical Form

In the subject application, as seen in a clockwise direction or in an anti-clockwise direction of the cross-section of the elongated body 110, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, each soft-magnetic element 112 has an overall conical form.

In a first embodiment, the overall conical form of the one or more soft-magnetic elements 112 is symmetrical about its central axis.

In a second embodiment, the overall conical form of the one or more soft-magnetic elements 112 is unsymmetrical about its central axis.

In a third embodiment, as shown in FIG. 11(A), the overall conical form of the one or more soft-magnetic elements 112 comprises one or more first slits 11211 disposed within.

In a fourth embodiment, as shown in FIG. 11(B), the overall conical form of the one or more soft-magnetic elements 112 has an outer contour comprising one or more first notches 11212.

### A Base

Then, still as seen in a clockwise direction or in an anti-clockwise direction of the cross-section of the elongated body 110, as shown in FIG. 10, FIG. 11 and FIG. 12, each soft-magnetic element 112 has a base 1121, from which the conical form extends and with which it integrates. In particular, the base 1121 is configured to be close to and facing the radial non-magnetic gap 20.

In a first embodiment, as shown in FIG. 10 and FIG. 11, the base 1121 of one or more soft-magnetic elements 112 tapers to form a first free 11213 end on one side and a second free end 11214 on the opposite side, such that the first free end 11213 and the second free end 11214 of the bases 1121 of adjacent soft-magnetic elements 112 have either no surface contact or a minimum surface contact length with one another that extends along the radial dimension.

In a first implementation of the first embodiment, when there is no surface contact between the first free end 11213 and the second free end 11214 of adjacent soft-magnetic elements 112, there is a predetermined angular distance between the first free end 11213 and the second free end 11214 that is 0.1% to 20% of the radial dimension.

In a first implementation of the first embodiment, when there is a minimum contact length between the first free end 11213 and the second free end 11214 of adjacent soft-magnetic elements 112, it constitutes less than or equal to 20% of the radial dimension.

In a second embodiment, the contour profile of the base 1121 of one or more soft-magnetic elements 112, extending between the first free end 11213 and the second free end 11214, exhibits profile variations.

In a first implementation of the second embodiment, as shown in FIG. 11(B), the contour profile of the base 1121 comprises one or more peaks.

In a second implementation of the second embodiment, as shown in FIG. 11(B), the contour profile of the base 1121 comprises one or more valleys.

In a third implementation of the second embodiment, the contour profile of the base 1121 comprises a series of peaks and valleys resembling a serrated or zigzag line.

In a fourth implementation of the second embodiment, as shown in FIG. 10 and FIG. 11(A), the contour profile of the base 1121 comprises a smooth rounded profile.

### A Top

Further, still as seen in a clockwise direction or in an anti-clockwise direction of the cross-section of the elongated body 110, as shown in FIG. 2, FIG. 3, FIG. 4, FIG. 5, FIG. 6, FIG. 7, FIG. 8, FIG. 9, FIG. 10, FIG. 11, FIG. 12 and FIG. 13, each soft-magnetic element 112 has a top 1122 oriented that is oriented opposite the radial non-magnetic gap 20.

### Tapered Concave-Shaped Lateral Flanks

Finally, still as seen in a clockwise direction or in an anti-clockwise direction of the cross-section of the elongated body 110, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, each soft-magnetic element 112 has tapered concave-shaped lateral flanks 1123 that extend from the base 1121 and converge towards the top 1122. Furthermore, the tapered concave-shaped lateral flanks 1123 have a decreasing profile width towards the top 1122, potentially forming a point.

In an embodiment, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, for one or more soft-magnetic elements 112, the tapered concave-shaped lateral flanks 1123 progressively narrow, at an uninterrupted gradient, towards the top 1122, thereby tracing a smoothly curving flank profile.

### Permanent Magnet Arrangements

In the subject application, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, the cross-section of the elongated body 110 comprises a plurality of permanent magnet arrangements 113.

In the subject application, each permanent magnet arrangement 113 comprises one or more permanent magnets 1130.

In the subject application, the permanent magnets 1130 are arranged to be relative to each other and circumferentially adjacent to one another around the central longitudinal rotation axis 111.

FIG. 8 shows a first embodiment arrangement of the permanent magnet arrangements 113, each comprising permanent magnets 1130.

FIG. 9 shows a first embodiment arrangement of the permanent magnet arrangements 113, each comprising three permanent magnets 1130.

However, other numbers of permanent magnets 1130 per permanent magnet arrangements 113 may be contemplated, without requiring any substantial modification of the subject application.

Also, as shown in FIG. 1, FIG. 2, FIG. 3, FIG. 4, FIG. 5, FIG. 6, FIG. 7, FIG. 8, FIG. 9, FIG. 10, FIG. 11, FIG. 12 and FIG. 13, each permanent magnet arrangement 113 is individually flanked by the space 1120 defined between a pair of adjacent soft-magnetic elements 112.

### Configuration of Permanent Magnets Flanking a Soft Magnetic Element

Further, in the subject application, as shown in FIG. 8 and FIG. 9, the permanent magnets 1130 that are flanking opposite sides of a soft-magnetic element 112 have identical magnetic polarity oriented to concentrate magnetic flux within said soft-magnetic element 112.

In a first embodiment, as shown in FIG. 12(A), the one or more permanent magnets 1130 within the one or more permanent magnet arrangement 113 comprise one or more second slits 11311 disposed within.

In a second embodiment, as shown in FIG. 12(B), the one or more permanent magnets 1130 within the one or more permanent magnet arrangement 113 have an outer contour comprising one or more second notches 11312.

### First Embodiment of the Radial Permanent Magnet Synchronous Machine Rotor Assembly: Halbach Effect Production from Predetermined Orientation Sequence of Permanent Magnet Pairs Flanking a Soft-Magnetic Element

The inventors have found that specific arrangement of pairs of permanent magnet arrangements generates a flux concentration in the radial non-magnetic gap 20. This way, the rotor magnetic flux density magnitude is increased, resulting in a higher output torque of the machine.

In that first embodiment, as shown in FIG. 9, one or more pairs of permanent magnet arrangements 113, having more than one permanent magnets 1130 and that are flanking opposite sides of a soft-magnetic element 112, have a predetermined magnetic polarity orientation sequence that creates a Halbach effect with that soft-magnetic element 112, thereby producing an augmented magnetic field concentrated within said soft-magnetic element 112 that is flanked.

In other words, the described Halbach-effect arrangement has a specific magnet polarity pattern, where the typical central radially magnetized permanent magnet in a standard Halbach array is replaced by the soft magnetic element 112 instead.

This means that the otherwise middle magnet is substituted by the encircled soft-metal part 112, creating a distinct sequence. As depicted in FIG. 9 for instance, the embodiment illustrates the soft magnetic piece 112 flanked by particular pole orientations of multiple permanent magnets 113 and their sub-magnets 1130 in an adapted structure.

By integrating the soft-magnetic element 112 within the magnet polarity layout this way, a unique flux-concentrated configuration emerges from this inventive approach. The precise terminology conveys the special patterning at hand through factual descriptions.

### Second Embodiment of the Radial Permanent Magnet Synchronous Machine Rotor Assembly: Mechanical Attachment of the Rotor

In that second embodiment, as shown in FIG. 13, one or more pairs of permanent magnet arrangements 113 have a rotor support 114 that extend from the respective top 1122 in a direction opposite the radial non-magnetic gap 20.

In an example of the second embodiment, as seen in a clockwise direction or in an anti-clockwise direction of the cross-section of the elongated body 110, as shown in FIG. 13, the rotor support 114 has an overall conical form.

However, other shapes of the rotor support 114 may be contemplated, without requiring any substantial modification of the subject application.

### An Axial Permanent Magnet Synchronous Machine Rotor Assembly

The subject application also relates to a second permanent magnet rotor assembly specifically designed and built for use in an axial permanent magnet synchronous machine having a stator.

As used herein, the term ‘specifically designed and built for’ is meant to safeguard against inapplicable rotors being improperly interpreted as anticipatory prior art based on superficial resemblance alone, despite the lack of aptness for the stated radial flux machine application without further changes.

Indeed, the term ‘specifically designed and built for use in an axial permanent magnet synchronous machine’ serves to emphasize that the claimed rotor assembly is explicitly engineered and manufactured for the particular application specified. This excludes the possibility of any known product, even if superficially similar, being construed as anticipatory if in reality it is unsuitable for direct use in such a radial flux machine context without modification.

The phrasing indicates that a rotor requiring adaptations to enable functioning as prescribed in the radial synchronous machine falls outside the scope of the claim's novelty. Rather, only a previously existing rotor structure simultaneously designed AND fabricated AND capable of actual operability within the claimed machine without adjustments could potentially challenge novelty.

The axial permanent magnet synchronous machine is of known type and therefore will not be further detailed.

The stator is of a known type. For instance, the stator may comprise windings that are arranged in a double-layer concentrated configuration specified by the “12/10” ratio between stator and rotor pole pairs (e.g. 60 vs 50). Also, to generate the required rotating magnetic flux, a dual three-phase winding scheme may be utilized. However, since the stator may use a standardized layout which is well established in electrical machine design, it will not be further detailed.

### Structure of the Second Permanent Magnet Rotor Assembly

### An Elongated Body

Referring to FIG. 14, the second permanent magnet rotor assembly 200 comprises an elongated body 210.

In an embodiment, the elongated body 210 has a substantially cylindrical shape with desired dimensions.

In an example, the elongated body 210 is a tubular body.

In another example, the elongated body 210 is a hollow cylinder body.

Further, in the subject application, the elongated body 210 has a central longitudinal rotation axis 211, a circumference and a longitudinal section.

As used herein, the term ‘circumference’ is defined as an external circumferential surface of the elongated body 210.

Further, the longitudinal section is seen in a plane parallel to the central longitudinal rotation axis 211.

Particularly, the longitudinal section exhibits an axial dimension and a radial dimension perpendicular to the axial dimension.

Also, the longitudinal section has a 3D flux-carrying surface conforming to the internal shape of the elongated body 210, mapped along its entire length.

As used herein, the term ‘3D flux-carrying surface’ refers to the three-dimensional internal surface of the elongated body 210 that interacts with the axial magnetic flux in the axial permanent magnet synchronous machine.

### Soft-Magnetic Elements

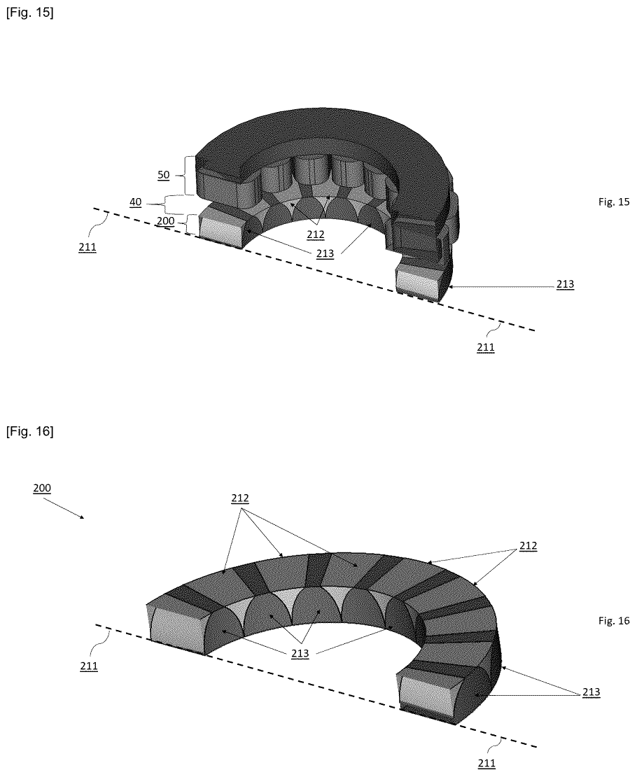

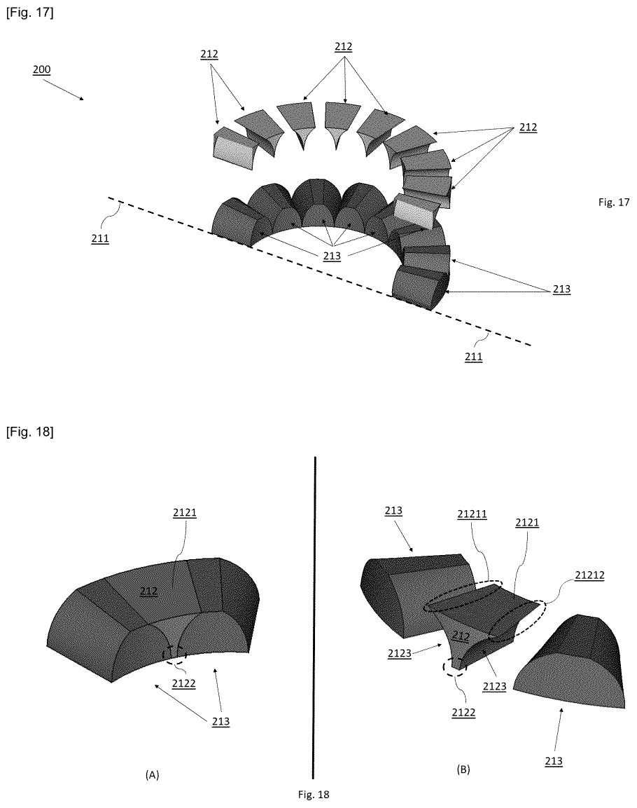

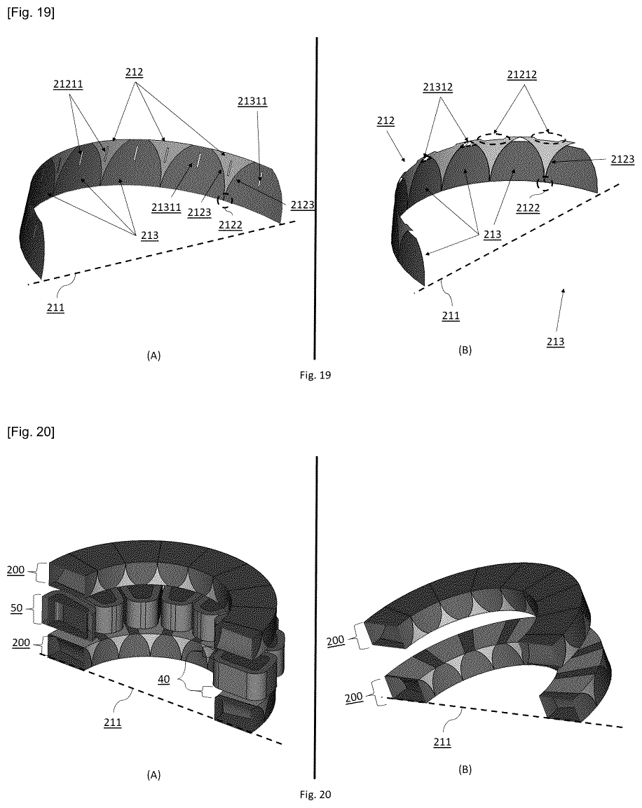

In the subject application, as shown in FIG. 14, FIG. 15, FIG. 16, FIG. 17, FIG. 18, FIG. 19, and FIG. 20, the longitudinal section of the elongated body 210 comprises one or more soft-magnetic elements 212.

### Soft-Magnetic Elements Material

In the subject application, the one or more soft-magnetic elements 212 are made of soft-magnetic material.

As used herein, the term ‘soft’ in ‘soft-magnetic material’ doesn't refer to the physical hardness of the material, but rather its ‘magnetic softness’, i.e., its ability to become magnetized and demagnetized easily.

In an embodiment, the soft-magnetic material is a soft ferromagnetic material which has a permanent spontaneous magnetization persisting without an external field.

In an example of the current embodiment, the soft ferromagnetic material is chosen from the group comprising: a ferrite, iron powder, bulk iron, cobalt and nickel.

However, other materials that have a magnetic permeability greater than that of air may be contemplated, without requiring any substantial modification of the subject application.

### Arrangement of Soft Magnetic Elements Relative to the 3D Flux-Carrying Surface

In the subject application, the one or more soft-magnetic elements 212 are extending in both the axial and radial dimensions.

In the subject application, as shown in FIG. 15, FIG. 16, FIG. 17, FIG. 18, and FIG. 20, the one or more soft-magnetic elements 212 are arranged along the 3D flux-carrying surface, conforming to the shape of 3D flux-carrying surface and following the direction of the central longitudinal rotation axis.

In the subject application, as shown in FIG. 14, FIG. 15, FIG. 16, FIG. 17, FIG. 18, FIG. 19, and FIG. 20, the one or more soft-magnetic elements 212 are further arranged to be relative to each other and adjacent to one another.

Moreover, the one or more soft-magnetic elements 212 are also arranged to be spaced apart, with a space existing between each adjacent pair of soft-magnetic elements 212.

In a first embodiment, the soft-magnetic elements 212 are arranged to be evenly spaced apart, with the space between each adjacent pair of soft-magnetic elements 212 being substantially equal.

In a second embodiment, the soft-magnetic elements 212 are arranged with variable spacing, with the space between each adjacent pair of soft-magnetic elements 212 varying.

As a result of the arrangement of the one or more soft-magnetic elements 212, as shown in FIG. 15 and FIG. 20(A), an axial non-magnetic gap 40 is created between a stator 50 and the 3D flux-carrying surface along the central longitudinal rotation axis 211.

In an example, the axial non-magnetic gap 40 comprises air.

In another example, the axial non-magnetic gap 40 comprises non-magnetic gases such as Nitrogen (N2), Carbon dioxide (CO2) or Helium sulfide.

In another example, the axial non-magnetic gap 40 comprises aluminum.

In another example, the axial non-magnetic gap 40 comprises plastic.

In another example, the axial non-magnetic gap 40 comprises resins such as carbon fiber/resin or fiberglass/epoxy resin.

In yet another example, the axial non-magnetic gap 40 comprises polymers such as ceramic/polymer composites (i.e., silicon nitride in an epoxy matrix).

However, the axial non-magnetic gap 40 may comprise other materials that have non-magnetic conductive properties, without requiring any substantial modification of the subject application.

### An Overall Conical Form

In the subject application, as seen in the axial direction of the longitudinal section of the elongated body 210, as shown in FIG. 14, FIG. 15, FIG. 16, FIG. 17, FIG. 18, FIG. 19, and FIG. 20, each soft-magnetic element 212 has an overall conical form.

In a first embodiment, the overall conical form of the one or more soft-magnetic elements 212 is symmetrical about its central axis.

In a second embodiment, the overall conical form of the one or more soft-magnetic elements 212 is unsymmetrical about its central axis.

In a third embodiment, as shown in FIG. 19(A), the overall conical form of the one or more soft-magnetic elements 212 comprises one or more third slits 21211 disposed within.

In a fourth embodiment, as shown in FIG. 19(B), the overall conical form of the one or more soft-magnetic elements 212 has an outer contour comprising one or more third notches 21212.

### A Base

Then, still as seen in the axial direction of the longitudinal section of the elongated body 210, as shown in FIG. 18, each soft-magnetic element 212 has a base 2121, from which the conical form extends and with which it integrates. In particular, the base 2121 is configured to be close to and facing the axial non-magnetic gap 40.

In a first embodiment, as shown in FIG. 18(B), the base 2121 of one or more soft-magnetic elements 212 tapers to form a first free end 21211 on one side and a second free end 21212 on the opposite side, such that the first free end 21211 and the second free end 21212 of the bases 2121 of adjacent soft-magnetic elements 112 have either no surface contact or a minimum surface contact length with one another that extends along the axial dimension.

In a first implementation of the first embodiment, as shown in FIG. 15, FIG. 16, FIG. 19 and FIG. 20, when there is no surface contact between the first free end 21211 and the second free end 21212 of adjacent soft-magnetic elements 212, there is a predetermined angular distance between the first free end 21211 and the second free end 21212 that is 0.1% to 20% of the axial dimension.

In a first implementation of the first embodiment, when there is a minimum contact length between the first free end 21211 and the second free end 21212 of adjacent soft-magnetic elements 212, it constitutes less than or equal to 20% of the axial dimension.

In a second embodiment, the contour profile of the base 2121 of one or more soft-magnetic elements 212, extending between the first free end 21211 and the second free end 21212, exhibits profile variations.

In a first implementation of the second embodiment, as shown in FIG. 19(B), the contour profile of the base 2121 comprises one or more peaks.

In a second implementation of the second embodiment, as shown in FIG. 19(B), the contour profile of the base 2121 comprises one or more valleys.

In a third implementation of the second embodiment, the contour profile of the base 2121 comprises a series of peaks and valleys resembling a serrated or zigzag line.

In a fourth implementation of the second embodiment, as shown in FIG. 14, FIG. 15, FIG. 16, FIG. 17, FIG. 18, FIG. 19(A), and FIG. 20, the contour profile of the base 2121 comprises a smooth rounded profile.

### A Top

Further, still as seen in the axial direction of the longitudinal section of the elongated body 210, as shown in FIG. 18 and FIG. 19, each soft-magnetic element 212 has a top 2122 that is oriented opposite the axial non-magnetic gap 40.

### Tapered Concave-Shaped Lateral Flanks

Finally, still as seen in the axial direction of the longitudinal section of the elongated body 210, as shown in FIG. 14, FIG. 15, FIG. 16, FIG. 17, FIG. 18, FIG. 19, and FIG. 20, each soft-magnetic element 112 has tapered concave-shaped lateral flanks 2123 that extend from the base 2121 and converge towards the top 2122. Furthermore, tapered concave-shaped lateral flanks 2123 have a decreasing profile width towards the top 2122, potentially forming a point.

In an embodiment, as shown in FIG. 14, FIG. 15, FIG. 16, FIG. 17, FIG. 18, FIG. 19, and FIG. 20, for one or more soft-magnetic elements 212, the tapered concave-shaped lateral flanks 2123 progressively narrow, at an uninterrupted gradient, towards the top 2122, thereby tracing a smoothly curving flank profile.

### Permanent Magnet Arrangements

In the subject application, as shown in FIG. 14, FIG. 15, FIG. 16, FIG. 17, FIG. 18, FIG. 19, and FIG. 20, the longitudinal section of the elongated body 210 also comprises a plurality of permanent magnet arrangements 213.

In the subject application, each permanent magnet arrangement 213 comprises one or more permanent magnets.

In the subject application, the permanent magnets are arranged to be relative to each other and circumferentially adjacent to one another around the central longitudinal rotation axis 211, as described above for the first permanent magnet rotor assembly 100.

Also, each permanent magnet arrangement 213 is individually flanked by the space defined between a pair of adjacent soft-magnetic elements 212.

### Configuration of Permanent Magnets Flanking a Soft Magnetic Element

Further, in the subject application, the permanent magnets that are flanking opposite sides of a soft-magnetic element 212 have identical magnetic polarity oriented to concentrate magnetic flux within said soft-magnetic element 212, as described above for the first permanent magnet rotor assembly 100.

In a first embodiment, as shown in FIG. 19(A), the one or more permanent magnets within the one or more permanent magnet arrangement 213 comprise one or more fourth slits 21311 disposed within.

In a second embodiment, as shown in FIG. 19(B), the one or more permanent magnets within the one or more permanent magnet arrangement 213 have an outer contour comprising one or more fourth notches 21312.

### An Embodiment of the Axial Permanent Magnet Synchronous Machine Rotor Assembly: Halbach Effect Production from Predetermined Orientation Sequence of Permanent Magnet Pairs Flanking a Soft-Magnetic Element

The inventors have found that specific arrangement of pairs of permanent magnet arrangements generates a flux concentration in the axial non-magnetic gap 40. This way, the rotor magnetic flux density magnitude is increased, resulting in a higher output torque of the machine.

In that embodiment, as described above for the first permanent magnet rotor assembly 100, one or more pairs of permanent magnet arrangements 213, having more than one permanent magnets and that are flanking opposite sides of a soft-magnetic element 212, have a predetermined magnetic polarity orientation sequence that creates a Halbach effect with that soft-magnetic element 212, thereby producing an augmented magnetic field concentrated within said soft-magnetic element 212 that is flanked.

In other words, the described Halbach-effect arrangement has a specific magnet polarity pattern, where the typical central radially magnetized permanent magnet in a standard Halbach array is replaced by the soft magnetic element 212 instead.

This means that the otherwise middle magnet is substituted by the encircled soft-metal part 212, creating a distinct sequence.

By integrating the soft-magnetic element 212 within the magnet polarity layout this way, a unique flux-concentrated configuration emerges from this inventive approach. The precise terminology conveys the special patterning at hand through factual descriptions.

### An Axial or Radial Permanent Magnet Synchronous Machine Comprising the Permanent Magnet Rotor Assembly of the Subject Application

The subject application also relates to an axial or radial permanent magnet synchronous machine that has a stator 30, 50 and comprises at least one first permanent magnet rotor assembly 100 or at least one second permanent magnet rotor assembly 200, as described above.

In an example, the axial or radial permanent magnet synchronous machine is a motor in a drive or assembly.

In another example, the axial or radial permanent magnet synchronous machine is part of a motor in a drive or assembly.

For instance, the motor is either a single phase or a multi-phase motor.

In yet another example, the axial or radial permanent magnet synchronous machine is a generator in a drive or assembly.

In yet another example, the axial or radial permanent magnet synchronous machine is part of a generator in a drive or assembly.

In yet another example, as shown in FIG. 20, the axial permanent magnet synchronous machine is a double-sided assembly comprising two second permanent magnet rotor assemblies 200 sandwiching the stator 50, while still preserving the axial non-magnetic gap 40.

### Working Machines Comprising the Synchronous Reluctance Machine of the Subject Application

The subject application also relates to a working machine that comprises an axial or radial permanent magnet synchronous machine as described above.

In an embodiment, the working machine is in the form of a vehicle.

In an example, the vehicle is a terrestrial vehicle such as a car, a cab, a bus or a train.

In another example, the vehicle is a water vehicle such as a boat, a ferry or a cruiser.

In yet another example, the vehicle is an aircraft such a plane, a helicopter, a glider, an aerostat or air ship.

However, the working machine can be any suitable electrical machine, such as a machine tool or the like.

### Manufacturing Method of the Second Permanent Magnet Rotor Assembly

The subject application also relates to a method for producing the second permanent magnet rotor assembly 200 describe above.

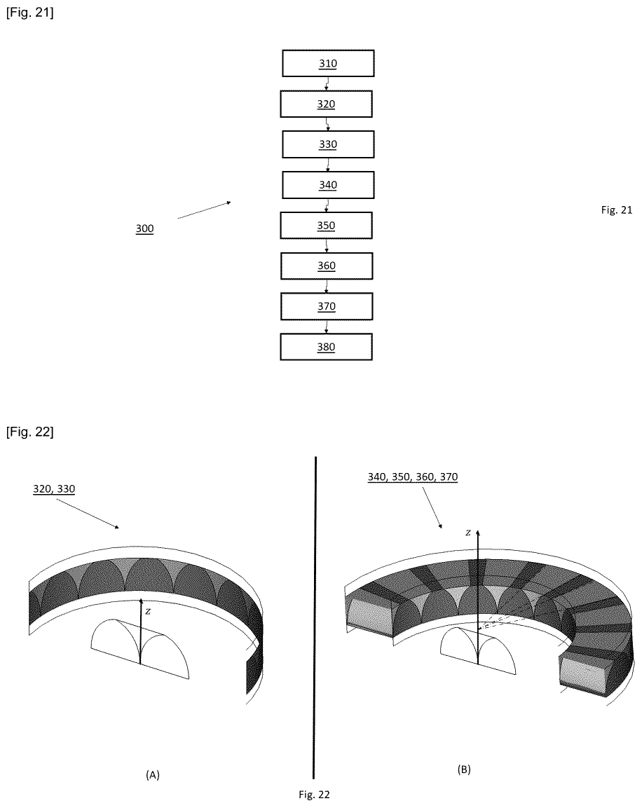

Indeed, as shown in FIG. 21, the method 300 is specifically intended for manufacturing a second permanent magnet rotor assembly 200 specifically designed and built for use in an axial permanent magnet synchronous machine having a stator 50.

As used herein, the terminology ‘specifically intended for producing’ serves to construe the manufacturing result as an integral functional feature of the claimed fabrication method. The stated purpose to create a defined rotor assembly relates to requisite process steps, not merely suitability therefor.

Indeed, the phrasing ‘specifically intended for producing [the axial rotor]’ indicates that yielding the target axial rotor structure itself defines part of the disclosed method's novelty. Any process inherently incapable of enabling fabrication of the stated axial rotor without further modifications would thus fail to fulfill the intended novel functionality.

The phrasing aims to exclude prior methods which cannot inherently achieve the claimed fabrication purposes without adjustments. Only an existing process designed and operable to directly yield the specified axial rotor final structure could potentially challenge novelty of the manufacturing approach as a whole.

In step 310, as shown in FIG. 22(A), there is provided at least one elongated hollow cylinder body having a central longitudinal rotation axis 211, a circumference, an axial length and a 3D flux-carrying surface conforming to the internal shape of the elongated body, mapped along its entire length. Particularly, the elongated hollow cylinder body is made of soft-magnetic material.

In step 320, as shown in FIG. 22(A), there is provided a cross-section of the first permanent magnet rotor assembly 100 as described above.

In step 330, as shown in FIG. 22(A), there is projected the cross-section of the first permanent magnet rotor assembly 100 onto the 3D flux-carrying surface thereby forming a projected pattern on the 3D flux-carrying surface.

In step 340, as shown in FIG. 22(B), there is extended the projected pattern along a circular cross-section of the elongated hollow cylinder body in a direction that is radial relative to the circular cross-section, thereby forming an extended projected pattern.

In step 350, as shown in FIG. 22(B), there is dug into the width of the elongated hollow cylinder body according to the extended projected pattern in order to form one or more soft-magnetic elements 212 that are extending in both the axial and radial dimensions and that are arranged along the 3D flux-carrying surface, conforming to the shape of 3D flux-carrying surface and following the direction of the central longitudinal rotation axis.

In step 360, as shown in FIG. 22(B), there is further arranged the one or more soft-magnetic elements 212,
to be relative to each other and adjacent to one another, and
to be spaced apart, with a space existing between each adjacent pair of soft-magnetic elements 112.

As a result of the arrangement of the one or more soft-magnetic elements 212, as described above with respect to the second permanent magnet rotor assembly 200, an axial non-magnetic gap 40 is created between the stator 50 and the 3D flux-carrying surface along the central longitudinal rotation axis 211.

In step 370, as shown in FIG. 22(B), there is arranged a plurality of permanent magnet arrangements 213, each permanent magnet arrangement 213 comprising one or more permanent magnets and being individually flanked by the space defined between a pair of adjacent soft-magnetic elements 212.

Furthermore, the second permanent magnet rotor assembly 200 is so arranged that, as seen in the axial direction of the longitudinal section of the elongated body 210,
each soft-magnetic element 212 has,
   an overall conical form,
   a base 2121, from which the conical form extends and with which it integrates, configured to be close to and facing the axial non-magnetic gap 40,
   a top 2122 oriented opposite the axial non-magnetic gap 40,
   tapered concave-shaped lateral flanks 2123 that extend from the base 2121 and converge towards the top 2122, and have a decreasing profile width towards the top 2122, potentially forming a point, and wherein,
   the permanent magnets flanking opposite sides of a soft-magnetic element 212 have identical magnetic polarity oriented to concentrate magnetic flux within said soft-magnetic element 212.

### An Embodiment of the Manufacturing Method of the Second Permanent Magnet Rotor Assembly: Halbach Effect Production from Predetermined Orientation Sequence of Permanent Magnet Pairs Flanking a Soft-Magnetic Element

The inventors have found that specific arrangement of pairs of permanent magnet arrangements exhibits improvements relative to the torque.

In that embodiment, as shown in FIG. 21, the method 300 further comprises the step 380 of having, for one or more pairs of permanent magnet arrangements 213, having more than one permanent magnets and that are flanking opposite sides of a soft-magnetic element 212, a predetermined magnetic polarity orientation sequence that creates a Halbach effect with that soft-magnetic element 212, thereby producing an augmented magnetic field concentrated within said soft-magnetic element 212 that is flanked.

The description of the subject application has been presented for purposes of illustration and description but is not intended to be exhaustive or limited to the application in the form disclosed. The embodiments were chosen and described to better explain the principles of the application and the practical application, and to enable the skilled person to understand the application for various embodiments with various modifications as are suited to the particular use contemplated.

1. A first permanent magnet rotor assembly specifically designed and built for use in a radial permanent magnet synchronous machine having a stator, the first permanent magnet rotor assembly comprising:
an elongated body having a central longitudinal rotation axis, a circumference and a cross-section,
the cross-section of the elongated body exhibiting an external circumferential dimension and a radial dimension perpendicular to the external circumferential dimension, the cross-section having a perimeter line delimiting a contour of the cross-section, the cross-section of the elongated body comprising:
one or more soft-magnetic elements made of soft-magnetic material, positioned with respect to the perimeter line so as to extend above or below the perimeter line, which soft-magnetic elements are arranged,
to be relative to each other and circumferentially adjacent to one another around the central longitudinal rotation axis, and
to be spaced apart circumferentially, with a space existing between each adjacent pair of the soft-magnetic elements,
thereby resulting in the creation of a circumferential radial non-magnetic gap between the stator and the perimeter line of the cross-section,
a plurality of permanent magnet arrangements, each permanent magnet arrangement comprising one or more permanent magnets and being individually flanked by the space defined between a said pair of adjacent soft-magnetic elements,
wherein, as seen in a clockwise direction or anti-clockwise direction of the cross-section of the elongated body,
each soft-magnetic element has,
an overall conical form,
a base, from which the conical form extends and with which it integrates, configured to be close to and facing the circumferential radial non-magnetic gap,
a top oriented opposite the circumferential radial non-magnetic gap, and
tapered concave-shaped lateral flanks that extend from the base and converge towards the top, and have a decreasing profile width towards the top, thereby tracing a smoothly curving flank profile, potentially forming a point, wherein,
the permanent magnets flanking opposite sides of a said soft-magnetic element have identical magnetic polarity oriented to concentrate magnetic flux within said soft-magnetic element.

2. The first permanent magnet rotor assembly of claim 1, wherein the overall conical form of the one or more of the one or more soft-magnetic elements comprises one or more first slits disposed within.

3. The first permanent magnet rotor assembly of claim 1, wherein the overall conical form of the one or more soft-magnetic elements has an outer contour comprising one or more first notches.

4. The first permanent magnet rotor assembly of claim 1, wherein the base of one or more said soft-magnetic elements tapers to form a first free end on one side and a second free end on an opposite side, such that the first free end and the second free end of the bases of adjacent soft-magnetic elements have either no surface contact or a minimum surface contact length with one another that extends along the radial dimension.

5. The first permanent magnet rotor assembly of claim 4, wherein when there is no surface contact between the first free end and the second free end of adjacent soft-magnetic elements, there is a predetermined angular distance between the first free end and the second free end that is 0.1% to 20% of the radial dimension.

6. The first permanent magnet rotor assembly of claim 4, wherein when there is a minimum contact length between the first free end and the second free end of adjacent soft-magnetic elements, it constitutes less than or equal to 20% of the radial dimension.

7. The first permanent magnet rotor assembly of claim 4, wherein a contour profile of the base of one or more said soft-magnetic elements, extending between the first free end and the second free end, exhibits profile variations.

8-9. (canceled)

10. The first permanent magnet rotor assembly of claim 1, wherein one or more pairs of said permanent magnet arrangements, having more than one permanent magnet and flanking opposite sides of a said soft-magnetic element, have a predetermined magnetic polarity orientation sequence that creates a Halbach effect with said soft-magnetic element, thereby producing an augmented magnetic field concentrated within said soft-magnetic element that is flanked.

11. The first permanent magnet rotor assembly of claim 1, wherein the one or more permanent magnets within the one or more permanent magnet arrangement comprise one or more second slits disposed within.

12. The first permanent magnet rotor assembly of claim 1, wherein the one or more permanent magnets within the one or more permanent magnet arrangement have an outer contour comprising one or more second notches.

13. A second permanent magnet rotor assembly specifically designed and built for use in an axial permanent magnet synchronous machine having a stator, the second permanent magnet rotor assembly comprising:
an elongated body having a central longitudinal rotation axis, a circumference and a longitudinal section, the longitudinal section of the elongated body exhibiting an axial dimension and a radial dimension perpendicular to the axial dimension, the longitudinal section having a 3D flux-carrying surface conforming to an internal shape of the elongated body, mapped along its entire length, the longitudinal section of the elongated body comprising:
one or more soft-magnetic elements made of soft-magnetic material, that are extending in both the axial and radial dimensions and that are arranged along the 3D flux-carrying surface, conforming to a shape of 3D flux-carrying surface and following a direction of the central longitudinal rotation axis, which soft-magnetic elements are further arranged,
to be relative to each other and adjacent to one another, and
to be spaced apart, with a space existing between each adjacent pair of the soft-magnetic elements,
thereby resulting in the creation of an axial non-magnetic gap between the stator and the 3D flux-carrying surface along the central longitudinal rotation axis,
a plurality of permanent magnet arrangements, each permanent magnet arrangement comprising one or more permanent magnets and being individually flanked by the space defined between a said pair of adjacent soft-magnetic elements,
wherein, as seen in the axial direction of the longitudinal section of the elongated body,
each soft-magnetic element has,
an overall conical form,
a base, from which the conical form extends and with which it integrates, configured to be close to and facing the axial non-magnetic gap,
a top oriented opposite the axial non-magnetic gap, and
tapered concave-shaped lateral flanks that extend from the base and converge towards the top, and have a decreasing profile width towards the top, thereby tracing a smoothly curving flank profile, potentially forming a point, wherein,
the permanent magnets flanking opposite sides of a said soft-magnetic element have identical magnetic polarity oriented to concentrate magnetic flux within said soft-magnetic element.

14. The second permanent magnet rotor assembly of claim 13, wherein one or more pairs of said permanent magnet arrangements, having more than one permanent magnets and flanking opposite sides of a said soft-magnetic element, have a predetermined magnetic polarity orientation sequence that creates a Halbach effect with said soft-magnetic element, thereby producing an augmented magnetic field concentrated within said soft-magnetic element that is flanked.

15. A method specifically intended for producing a second permanent magnet rotor assembly specifically designed and built for use in an axial permanent magnet synchronous machine having a stator, the method comprising:
providing at least one elongated hollow cylinder body having a central longitudinal rotation axis, a circumference, an axial length and a 3D flux-carrying surface conforming to an internal shape of the elongated body, mapped along its entire length, the elongated hollow cylinder body being made of soft-magnetic material,
providing a cross-section of the first permanent magnet rotor assembly according to claim 1,
projecting the cross-section of the first permanent magnet rotor assembly onto the 3D flux-carrying surface thereby forming a projected pattern on the 3D flux-carrying surface,
extending the projected pattern along a circular cross-section of the elongated hollow cylinder body in a direction that is radial relative to the circular cross-section thereby forming an extended projected pattern,
digging into a width of the elongated hollow cylinder body according to the extended projected pattern in order to form one or more said soft-magnetic elements that are extending in both the axial and radial dimensions and that are arranged along the 3D flux-carrying surface, conforming to the shape of 3D flux-carrying surface and following the direction of the central longitudinal rotation axis,
further arranging the one or more soft-magnetic elements,
to be relative to each other and adjacent to one another, and
to be spaced apart, with a space existing between each adjacent pair of soft-magnetic elements,
thereby resulting in the creation of an axial non-magnetic gap between the stator and the 3D flux-carrying surface along the central longitudinal rotation axis,
arranging a plurality of said permanent magnet arrangements, each permanent magnet arrangement comprising one or more permanent magnets and being individually flanked by the space defined between a said pair of adjacent soft-magnetic elements,
wherein, as seen in the axial direction of the longitudinal section of the elongated body,
each soft-magnetic element has,
an overall conical form,
a base, from which the conical form extends and with which it integrates, configured to be close to and facing the axial non-magnetic gap,
a top oriented opposite the axial non-magnetic gap,
tapered concave-shaped lateral flanks that extend from the base and converge towards the top, and have a decreasing profile width towards the top, potentially forming a point, and wherein,
the permanent magnets flanking opposite sides of a soft-magnetic element have identical magnetic polarity oriented to concentrate magnetic flux within said soft-magnetic element.
